(19) United States
(12) Patent Application Publication
(10) Pub. No.: US 2007/0221318 A1
(43) Pub. Date: Sep. 27, 2007

(54) Adhesion tape and method for mounting a chip onto a substrate

(76) Inventors: Martin Reiss, Dresden (DE); Bernd Scheibe, Dresden (DE); Stephan Blaszczak, Freyburg (DE)

Correspondence Address: SLATER & MATSIL LLP, 17950 PRESTON ROAD, SUITE 1000, DALLAS, TX, 75252, US

(21) Appl. No.: 11/389,550

(22) Filed: Mar. 24, 2006

(51) Int. Cl. B32B 37/00

(52) U.S. Cl. 156/249; 428/343; 156/344

(57) ABSTRACT

An adhesion tape can be used for transferring an adhesive material onto the underside of a chip for further mounting of the chip onto a substrate. In order to provide effective compensation of the curvature of the wafers and of the dies without adversely affecting the mounting process in this case, an adhesion tape having an at least two-layered adhesive layer is provided. The adhesive layer comprises a first and a second adhesive layer. Both adhesive layers can be cured selectively with respect to one another.

### TECHNICAL FIELD

Embodiments of the invention relate to an adhesion tape for transferring an adhesive material onto the underside of a chip, for further mounting of the chip onto a substrate and to methods for mounting a chip onto a substrate.

### BACKGROUND

Chips are nowadays integrated to an ever greater extent to form so-called IC packages in which a plurality of chips are stacked one above the other. These serve, for example, for increasing the storage density in memory circuits. Ever thinner chips are used for this purpose.

The thinning of the chips takes place prior to singulation of the chips if the latter are still joined together on the wafer. Essentially, two technologies are known for this purpose:

Firstly, in a GBD method (GBD=grinding before dicing), the wafer is applied by its active side onto a so-called grinding tape, which on the one hand protects the active layer during further treatment and on the other hand serves for fixably clamping the wafer. The back side of the wafer is then ground until the desired thickness is attained. A dicing tape is subsequently applied to the ground back side. The dicing tape is intended to hold the chips together in the wafer assembly in the further process. The dicing process then begins, in which the wafer is singulated into individual chips by the wafer being sawn up in grid-like fashion. In this case, the sawing cuts are effected into a depth such that the cohesion of the individual chips in the wafer assembly is not disturbed.

Afterward, the chips are picked up from the dicing tape and applied to a substrate or to an existing chip stack. For this purpose, use is made of an adhesive on the underside of the chip or on the top side of the substrate.

In another method, the so-called DBG method (DBG=dicing before grinding), the wafer is first clamped onto a dicing tape by its back side and sawn from the active side. In this case, however, the wafer is not severed. Rather, the cuts are only made partly into the depth of the wafer, so that the wafer assembly is still joined together. Afterward, the active layer is once again clamped onto a grinding tape and the back side is ground until the sawing cuts also appear on the back side and the chips are thus singulated.

For further mounting, the chips singulated in this way can then be provided with an adhesive material on their underside by adhesively attaching a DDAF tape (DDAF=direct die attach film). After removal of the grinding tape on the active side, the individual chips are then removed from the assembly on the DDAF tape. In this case, an adhesive layer from the DDAF tape adheres on the back side of the chip. With this adhesive layer, the removed chip is then applied to the substrate or the existing layer stack. The adhesive layer is then subjected to a curing process, for example by means of a thermal treatment or by means of irradiation with UV, depending on the material constitution.

The function of a DDAF tape can also be performed by the dicing tape in the GBD method, as is described for example in U.S. Patent Publication No. 2004/0213994 A1, which is incorporated herein by reference.

This document also provides a multilayered structure of the adhesive layer, which serves for improving the adhesive properties.

In endeavors to grind the wafer ever thinner in order then also to obtain thinner chips for mounting, limits are encountered, however. This is because when the thickness falls below a minimum thickness, the wafer and later the singulated chip are curved to an ever greater extent. This is associated with a difficult process implementation, on the one hand. On the other hand, this leads to reliability risks or a loss of yield.

The warpage is principally attributable to a bimetal-like effect since the active layer having a different coefficient of expansion than that of the silicon is situated on the chip. This effect is manifested to a greater extent, the thinner the chip becomes with the thickness of the active layer remaining the same.

At the present time, attempts are principally being made to solve the problem by means of the process implementation, but this will come up against limits as chip thicknesses are made ever thinner.

The adhesive that is removed from the carrier foil during an adhesive transfer cannot serve as compensation layer for the curvature either, since it is not until after curing during the connection to the substrate that the adhesive experiences the hardness required for compensation, and not beforehand. Curing effected before the chip is applied to the substrate is ruled out, since although the adhesive layer would then have compensation properties, it would lose its adhesive properties and stick on the carrier foil.

### SUMMARY OF THE INVENTION

In a first embodiment, the invention provides an adhesion tape having an at least two-layered adhesive layer. This adhesive layer comprises a first and a second adhesive layer. Both adhesive layers can be cured selectively with respect to one another. That is to say, if the wafer has been applied on the topmost second layer, the curing process for the second layer is carried out. As a result, the second layer on the one hand adheres to the underside of the wafer or the chip. Since the second layer also cures, on the other hand, it acts as a compensation layer counteracting the curvature. The first layer has not yet cured in this state and, consequently, still acts as an adhesive layer if the chip is applied to the substrate or the stack. Only then is the second adhesive layer cured as well.

The adhesion type may also be configured such that after curing of the second adhesive layer, after which the latter acts as a compensation layer, in the course of picking up the chip, the first adhesive layer, which is not yet cured, remains on the carrier foil. The chip can then only be transported with the cured second layer, the second layer having the function of the compensation layer and counteracting the curvature. The first layer remains on the carrier foil. The chip is then adhesively bonded onto the substrate by means of an adhesive that has already been applied to the substrate or the stack.

In this case, the first layer need even not intrinsically have any adhesive properties at all. It suffices if the layer itself does not cure during the curing of the second layer and forms a separating layer between the second layer and the carrier foil.

The method according to the invention provides for the wafer to be provided with the described two-layer adhesion tape on its back side. In this case, the second layer lies on the underside of the wafer. The adhesive material of the second layer is then subjected to a curing operation, as a result of which, on the one hand, it solidifies and can serve as a compensation layer and, on the other hand, it enters into a fixed connection with the underside of the wafer. The die is then picked up from the carrier foil. In this case, the first layer is also concomitantly stripped from the carrier foil and remains on the chip. Since this first layer is not yet cured, it serves as an adhesive layer for the subsequent chip mounting.

In another variant of the method, it is provided, then, that the second layer is cured and thus serves as a compensation layer, which is not taken along when the chip is picked up. As a result, the chip can then be mounted by means of an adhesive applied on the target location.

### DESCRIPTION OF THE DRAWINGS

For a more complete understanding of the present invention, and the advantages thereof, reference is now made to the following descriptions taken in conjunction with the accompanying drawing, in which:

FIG. 1 schematically shows an arrangement of a chip on a DDAF tape and the pick up thereof according to the prior art;

FIG. 2 schematically shows an arrangement of a chip on a DDAF tape and the pick up thereof according to the invention; and

FIG. 3 schematically shows an arrangement of a chip on an adhesion tape and the pick up thereof without the first adhesive layer being taken over.

The following list of reference symbols can be used in conjunction with the figures:
1 DDAF tape according to the prior art
2 Carrier foil
3 Adhesive layer
4 Chip
5 Active layer
6 Back side
7 Thickness
8 Removal tool
9 DDAF tape according to the invention
10 Compensation layer
11 Adhesion tape

### DETAILED DESCRIPTION OF ILLUSTRATIVE EMBODIMENTS

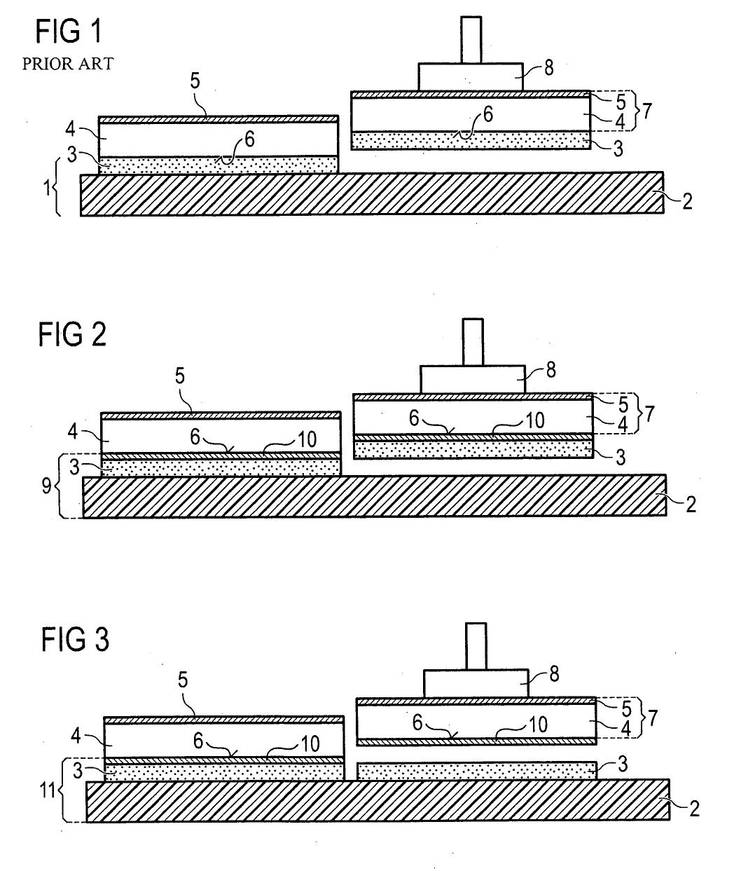

In a first configuration, the invention is explained on the basis of an adhesion tape designed as a DDAF tape. As illustrated in FIG. 1, a DDAF tape 1 according to the prior art comprises a carrier foil 2, on which an adhesive layer 3 is applied.

After singulation, a wafer has individual chips 4 each including an active layer 5 and a back side 6 opposite thereto. The wafer is firstly provided with the DDAF tape 1 by the DDAF tape 1 being applied to the back sides 6 of the chips 4 by means of the adhesive layer 3. The adhesive layer 3 has not yet been cured, but already has adhesive properties such that the DDAF tape adheres on the back sides 6. In this state, the wafer has already been thinned by grinding to its final thickness 7.

After the singulation, a chip 4 is then picked up from the DDAF tape 1 by means of a removal tool 8. In this case, the adhesive layer 3 is concomitantly transferred onto the back side 6 of the chip 4.

By virtue of different coefficients of expansion between the active layer 5 and the rest of the chip 4, a bi-metal effect may occur leading to warpage of the chip 4. However, mechanical forces as a result of the handling of the chip 4 also lead to undesirable deformations.

The adhesive layer 3 cannot compensate for this warpage since it is not yet cured until mounting of the chip 4 on a substrate—the so-called die attach process. On the other hand, the adhesive layer 3 cannot already be cured on the carrier foil 2 either, since it would then lose the adhesive properties, on the one hand, and also stick irreversibly on the carrier foil, on the other hand.

In FIG. 2, an adhesion tape according to the invention is designed as a two-layered DDAF tape 9. Reference symbols identical to those in FIG. 1 indicate mutually corresponding features. The DDAF tape 9 is provided with a compensation layer 10 applied to the side of the adhesive layer 3. This compensation layer 10, then, initially likewise exhibits sufficient adhesive properties such that the DDAF tape 9 can be placed onto the back sides 6 of the chips 4 and adheres thereon.

The compensation layer 10 is composed of a material that cures under different conditions than the adhesive layer 3. As a result, it now becomes possible for the compensation layer 10 to be completely cured without the adhesive layer 3 curing. The adhesive layer 3 still retains its full adhesive properties while the compensation layer 10, in the cured state, can counteract a flexure of the chip 4.

The compensation layer 10 may cure either at a different temperature or at a different wavelength than the adhesive layer 3. A hybrid material having a thermal and a UV curing layer is also possible. In any event, it is possible for the compensation layer 10 to be cured prior to the singulation of the wafer independently of the adhesive layer 3.

An advantage of this two-layered DDAF tape 9 arises from the fact that, on the one hand, the application of the compensation layer 10 enables arbitrarily thin chips 4 to be processed, since it can be adapted in a completely targeted manner to the thickness 7 of the chip 4 or the properties thereof or the thickness or the properties of the active layer 5. Since, on the other hand, the connection between the back side 6 of the chip 4 and the adhesive layer 3 is now effected via the compensation layer 10, the adhesive layer 3 can be adapted exactly to the requirements of the die attach process, in particular to the requirements of the package with regard to the package and module reliability.

FIG. 3 illustrates a second configuration of the invention, in which an adhesion tape according to the invention is designed as a two-layered adhesion tape 11. Reference symbols identical to those in FIG. 1 or FIG. 2 indicate mutually corresponding features. This adhesion tape does not serve for transferring an adhesive layer onto the chip 4. Rather, the adhesive layer 3 remains on the carrier foil during the picking up of the chip 4 after the compensation layer 10 has been cured selectively with respect to the adhesive layer 3. In this respect, the adhesive layer 3 need not have the properties for a die attach process. Rather, this process is carried out by means of a dedicated adhesive bonding process, for example by an adhesive being applied to the substrate. Rather, what is crucial is that it is possible in this way to apply to the back side 6 of the chip 4 a compensation layer 10 that counteracts a deformation of the thin chip 4 for the further process.

What is claimed is:

1. An adhesion tape comprising:
a substrate foil;
a first layer of adhesive material adjacent a surface of the substrate foil; and
a second layer of adhesive material adjacent a surface of the first layer, wherein a curing characteristic of the first layer is different from a curing characteristic of the second layer such that the first and second layers can be cured selectively with respect to each other.

2. The adhesion tape as claimed in claim 1, wherein the curing characteristic comprises curing temperature such that the first layer and the second layer are curable at different temperatures.

3. The adhesion tape as claimed in claim 2, wherein the curing temperature of the second layer is lower than the curing temperature of the first layer.

4. The adhesion tape as claimed in claim 1, wherein the curing characteristic comprises a curing wavelength such that the first layer and the second layer are curable under UV radiation with different wavelengths.

5. The adhesion tape as claimed in claim 1, wherein the curing characteristic of the first layer comprises a physical property that is different than the curing characteristic of the second layer.

6. The adhesion tape as claimed in claim 5, wherein the first layer comprises a temperature-curable material and the second layer comprises a UV-radiation-curable material.

7. The adhesion tape as claimed in claim 5, wherein the first layer comprises a UV-radiation-curable material and the second layer comprises a temperature-curable material.

8. An adhesion tape comprising:
a substrate foil;
a first layer of adhesive material adjacent a surface of the substrate foil; and
a second layer of adhesive material adjacent a surface of the first layer, wherein a curing characteristic of the first layer is different from a curing characteristic of the second layer for curing the second layers selectively with respect to the first layer.

9. The adhesion tape as claimed in claim 8, wherein the first layer of adhesive material and the second layer of adhesive material are curable at different temperatures.

10. The adhesion tape as claimed in claim 9, wherein the curing temperature of the second layer is lower than the curing temperature of the first layer.

11. The adhesion tape as claimed in claim 8, wherein the curable first layer of adhesive material and the second layer of adhesive material are under UV radiation with different wavelengths.

12. The adhesion tape as claimed in claim 8, wherein the material of the first layer is curable under different physical properties than the material of the second layer.

13. The adhesion tape as claimed in claim 12, wherein the first layer comprises a temperature-curable material and the second layer comprises a UV-radiation-curable material.

14. The adhesion tape as claimed in claim 12, wherein the first layer comprises a UV-radiation-curable material and the second layer comprises a temperature-curable material.

15. The adhesion tape as claimed in claim 8, wherein the first layer comprises a non-curable material and the second layer comprises a curable material.

16. A method of mounting a chip onto a substrate, the method comprising:
adhering a back side of a chip to an adhesion tape, the adhesion tape including a first layer of adhesive material and a second layer of adhesive material adjacent the first layer of adhesive material, wherein a curing characteristic of the first layer is different from a curing characteristic of the second layer;
curing the second layer of adhesive material to mechanically stabilize the chip, wherein the first layer remains uncured;
removing the chip from a substrate foil such that the first and second layers both remain adhered to the back side of the chip, wherein the removing includes stripping an upper surface of the first layer from the substrate foil;
attaching the chip to a substrate by placing the upper surface of the first layer on the substrate; and
curing the first layer.

17. The method as claimed in claim 16, wherein a curing temperature of the first layer is different from a curing temperature of the second layer.

18. The method as claimed in claim 17, wherein the curing temperature of the second layer is lower than the curing temperature of the first layer, the method further comprising exposing the chip with the adhesion tape to a temperature at least as high as the curing temperature of the second layer but lower than the curing temperature of the first layer prior to removing the chip from the substrate foil.

19. The method as claimed in claim 16, wherein the first layer is curable under radiation of a first wavelength and the second layer is curable under radiation of a second wavelength, the first wavelength being different than the second wavelength.

20. The method as claimed in claim 16, wherein the curing characteristic of the first layer comprises a different physical property than the curing characteristic of the second layer.

21. The method as claimed in claim 20, wherein the first layer comprises a temperature-curable material and the second layer comprises a UV-radiation-curable material.

22. The method as claimed in claim 20, wherein the first layer comprises a UV-radiation-curable material and the second layer comprises a temperature-curable material.

23. A method of mounting a chip onto a substrate, the method comprising:
providing a back side of a chip with an adhesion tape comprising a first layer of adhesive material and a second layer of adhesive material adjacent the first layer, wherein a curing characteristic of the first layer is different from a curing characteristic of the second layer such that the second layer can be cured selectively with respect to the first layer;
curing the second layer such that the first layer remains uncured;
removing the chip from a substrate foil such that the second layer is attached to the chip and the first layer is attached to the substrate foil, the removing being performed by stripping the second layer from the first layer; and
mounting the chip onto a substrate.

24. The method as claimed in claim 23, wherein a curing temperature of the first layer is different from a curing temperature of the second layer.

25. The method as claimed in claim 24, wherein the curing temperature of the second layer is lower than the curing temperature of the first layer.

26. The method as claimed in claim 23, wherein the first layer is curable under radiation of a first wavelength and the second layer is curable under radiation of a second wavelength, the first wavelength being different than the second wavelength.

27. The method as claimed in claim 23, wherein the curing characteristic of the first layer comprises a different physical property than the curing characteristic of the second layer.

28. The method as claimed in claim 27, wherein the first layer comprises a temperature-curable material and the second layer comprises a UV-radiation-curable material.

29. The method as claimed in claim 27, wherein the first layer comprises a UV-radiation-curable material and the second layer comprises a temperature-curable material.

30. The method as claimed in claim 23, wherein the first layer comprises a non-curable material and the second layer comprises a curable material.
